(19) United States
(12) Patent Application Publication
(10) Pub. No.: US 2007/0195655 A1
(43) Pub. Date: Aug. 23, 2007

(54) Drive for a changeable data carrier

(75) Inventor: Dirk Arenz, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/707,159

(22) Filed: Feb. 16, 2007

(30) Foreign Application Priority Data
Feb. 18, 2006 (DE) 10 2006 007 667.2

(51) Int. Cl. G11B 7/085

(52) U.S. Cl. 369/30.27

(57) ABSTRACT

A drive for a changeable data carrier is described. The drive has a reading unit for the read-out of data stored on the changeable data carrier, and has an integral reference surface, separate from the changeable data carrier, which can be scanned by the reading unit for reference purposes.

### CROSS REFERENCE TO RELATED APPLICATIONS

This application claims priority under 35 U.S.C. § 119 to German Patent Application No. 10 2006 007 667.2 filed Feb. 18, 2006, the entire disclosure of which is herein expressly incorporated by reference.

### BACKGROUND AND SUMMARY OF THE INVENTION

The invention relates to a drive for a changeable data carrier whose surface can be scanned by a reading unit for the read-out of data stored on the data carrier.

A reference data carrier, which may be a compact disc (CD) such as the ABEX Test CD by Almedio Inc., is frequently used for the checking and referencing of CD drives. For testing or referencing purposes, the reference CD is in this case temporarily inserted into the drive, instead of a user provided changeable data carrier.

A reference CD may have certain characteristic defects (such as scratches, finger prints, coatings, curvatures, etc.). The characteristic defects may be typically selected and provided such that they correspond to certain demands on the defect tolerance or robustness of the drive. A demand on the drive may, for example, include the fact that data carriers can still be played despite the presence of defects which are within specific defect limits (for example, scratches of a width of up to 1.6 mm). Defects within such defect limits (for example, scratches of a width of 1.6 mm) may correspondingly be included in the reference CD.

Checking a drive by means of a reference CD may have the purpose of finding out whether a discovered malfunction may be the result of a defect of the drive or of a defect of the data carrier. If the drive plays the reference CD correctly, a drive defect, such as an excessive cloudiness of the laser lens, can be excluded with a high probability.

Before performing any check or any referencing, the reference CD has to be inserted in the drive to be checked. This, like the storage and keeping of the reference CD between its uses, may lead to wear phenomena, for example, because of environmental influences. Such wear phenomena may corrupt the standardized fault image of the reference CD. In order to actually provide a standardized fault image, it is therefore necessary to replace the reference CD at regular time intervals. However, this results in expenditures with respect to cost and time. In addition, to be always available, the reference CD should be kept in the drive environment. To do so is often cumbersome, particularly in the case of drives in motor vehicles.

The exemplary embodiments according to the invention provide a device which permits an easy and comfortable checking or referencing of a drive. For example, an exemplary drive may include a device to hold a changeable data carrier whose surface can be scanned by a reading unit, able to read data stored on the changeable data carrier. The drive may include a reference surface, which is not part of the changeable data carrier, and which can be scanned by the reading unit for reference purposes.

Additional advantageous embodiments and further developments of the invention are described in the following text.

According to the invention, the drive includes a reference surface which is not part of an inserted data carrier, and which can be scanned for reference purposes by the reading unit of the drive. The reference surface may be therefore integrated as a permanent component within the drive.

The reference surface is therefore constantly available without having to be kept outside the drive in a readily accessible location. The reference surface is also not subject to wear due to environmental influences, because it is stored in the interior of the drive and is not handled by a user.

The scanning of the surface of an inserted data carrier or of the reference surface by the reading unit preferably takes place in a non-contact manner. According to a preferred embodiment of the present invention, the scanning takes place using a laser. However, the invention can also be applied to drives which scan the surface of an inserted data carrier or of the reference surface in other than a non-contact manner such as, for example, mechanically. In one embodiment, the invention can be applied to circular-disk-shaped data carriers, such as CDs or DVDs.

In one exemplary embodiment of the invention, the reference surface may be arranged on the side of a drive actuator facing the reading unit.

As a non-limiting example, it is assumed in the following that a data carrier inserted in the drive is held between a rotary disk and a holding disk, and that the reading unit of the drive is arranged on the side of the holding disk. However, a solution according to the invention may be analogously also obtained for a different construction of the drive.

In embodiments where the reading unit of the drive is arranged on the side of the holding disk, the reference surface may be arranged on the rotary disk which is provided for rotating an inserted data carrier. In order to have a reference surface, the rotary disk may be completely or partially provided with CD-like structures or other data structures containing characteristic defects. The reference surface may, for example, be produced by a special processing or by a special coating of the rotary disk. A permanent placing of a circular-disk-shaped attachment (in the end, similar to a reference data carrier according to the state of the art) on the surface of the rotary disk may also be used in some embodiments.

The above explanations relate to an embodiment in which the reading unit of the drive is arranged on the side of the holding disk. If, in contrast, the reading unit of the drive is arranged on the side of the rotary disk, the reference surface correspondingly may be arranged on the holding disk. In addition, a suitable mechanism may then be provided to ensure that the holding disk—corresponding or simulating to an inserted data carrier—is caused to rotate. This can take place by means of a separate drive of the holding disk or by pressing the holding disk onto the rotating disk.

To achieve the dimensions required for providing a suitable reference surface, it may be necessary, according to the present exemplary embodiment, to enlarge the rotary disk and holding disk respectively in comparison to those commonly used. The reference surface on the rotary disk and holding disk, respectively, can then approximate or if needed exactly match the dimensions of the data area of a data carrier.

When a changeable data carrier is placed in the drive, in a first embodiment of the invention, the reference surface is covered by the changeable data carrier and can therefore not be used. However, when the changeable data carrier is removed, the reading unit of the drive can scan the reference surface. Thus, while the drive is “unloaded”, a checking or referencing of the drive can take place.

In a second embodiment of the invention, the internal reference surface can be scanned by the reading unit also when a changeable data carrier is inserted in the drive. It can then, for example, be scanned routinely during each starting-up sequence of the drive, for both the checking and referencing thereof. The second embodiment of the invention requires a highly movable reading unit which is, for example, suitable for being completely or partially moved onto a back side of a rotatable drive actuator, which faces away from the reading unit in the normal operation. The reference surface may then be arranged on the facing-away or back side of the drive actuator. During scanning of the reference surface, the reading unit can then be completely or partially moved so it can read data on the back side of the drive actuator, even if a data carrier rests on the other side of the drive actuator (the side facing the reading unit in the normal operation).

In another embodiment, the reading unit and/or the reference surface may be movable such that the reading distance and/or the reading angle between the reading unit and the reference surface can be adjusted to correspond to the reading distance and/or the reading angle between the reading unit and an inserted changeable data carrier. For example, in the first embodiment of the invention described above, the reading unit of the drive will generally be farther away from the reference surface of the drive actuator than from the surface of a changeable data carrier resting on the drive actuator. According to the embodiment of the invention, a mechanism is provided which compensates for this difference and thereby avoids errors and false results during the checking and the referencing procedures. For example, the drive actuator can easily be movable closer to the reading unit when the drive is closed without inserting a data carrier. For compensating the different reading distance, the approachment distance of the drive actuator may correspond approximately to the thickness of a data carrier. The approachment is preferably not triggered before it is requested—for example, by means of an analysis command—that a checking and referencing of the drive is to take place. In a different embodiment, instead of moving the rotary disk closer to the reading unit, the reading unit can be moved closer to the rotary disk in order to correct the reading distance. This approachment can be implemented, for example, by means of a motor or by way of a spring mechanism.

Different embodiments of the invention may include provisions such that, at the beginning of a check or referencing, an inserted changeable data carrier is moved away from its provided usage position, in order to permit the reference surface to be scanned by the reading unit. For example, the check on referencing may be triggered by an analysis command, which may initiate without a manual user intervention and, for example, may be initiated by means of a transport mechanism of the drive.

The above embodiment is particularly advantageous with respect to a variant of the invention, as described above, where a checking or referencing would only otherwise be feasible without an inserted user data carrier. This further embodiment can be implemented easily in the case of drives and drive systems which are suitable for receiving multiple data carriers and for bringing one of these data carriers at a time into a usage position (such as CD changers for audio CDs in motor vehicles). The data carrier previously situated in the usage position can then be moved, without the user's manual intervention, by means of the transport mechanism of the CD changer into a storage position assigned to it in the magazine of the drive or of the drive system. The movement can automatically take place at the start of a checking or reference sequence, or upon receiving an operating command. After the checking or referencing is performed, the data carrier can automatically or upon a separate operating command be returned into the usage position.

In some embodiments, it may not be necessary to move the changeable data carrier into the magazine of the drive. It may, for example, be sufficient to only lift the data carrier away from the rotary disk. The important factor is that the reference surface can be accessed and therefore scanned by the reading unit. In the case of drives or drive systems suitable for receiving several data carriers and for moving one of those data carriers into a usage position, a suitable mechanism is generally already provided for this purpose. This mechanism only has to be made usable for the purpose of the invention by providing it with a corresponding control.

The invention permits a simple, consistently available and undemanding checking or referencing of a drive. According to the invention, the return for exchange/repair of drives or devices with an integrated drive can be avoided in cases where a detected malfunction is in fact the result of defective or incompatible data carriers. The invention also makes unnecessary the handling of an external reference data carrier, such as a reference CD, which is cumbersome and difficult in practice.

The above embodiments are principally directed to drives for circular-disk-shaped data carriers, such as CDs or DVD's. However, those of skill in the art will understand that the invention can analogously be applied to other types of drives and data carriers.

In the following, a preferred embodiment of the invention is explained in detail by means of the attached drawings.

Other objects, advantages and novel features of the present invention will become apparent from the following detailed description of the invention when considered in conjunction with the accompanying drawings.

### BRIEF DESCRIPTION OF THE DRAWINGS

FIG. 1 is a view of a data carrier according to the state of the art;

FIG. 2 is a view of a drive according to an embodiment of the present invention, with an inserted data carrier; and

FIG. 3 is a view of the drive shown in FIG. 2, without an inserted data carrier.

### DETAILED DESCRIPTION OF THE DRAWINGS

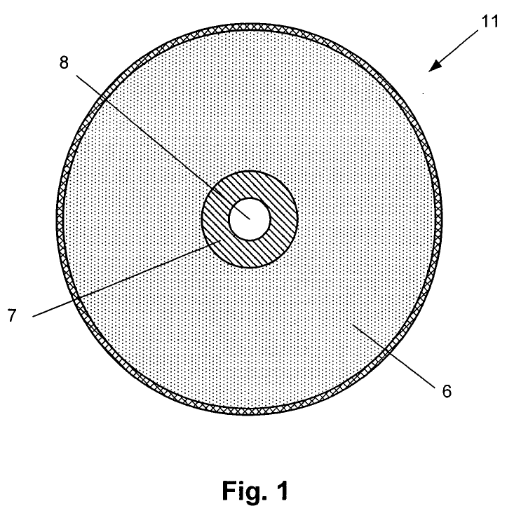

FIG. 1 illustrates a data carrier 11 according to the state of the art, which corresponds to the changeable data carrier described above. In this exemplary case, the data carrier is a compact disk (CD). The CD drive area 7 is situated around the opening 8. The CD optics area 6 extends around the CD drive area 7. In the normal operation of the CD in a drive, the drive area 7 comes in contact with a rotating drive actuator. As a result, the entire CD and therefore also the CD optics area 6 rotate.

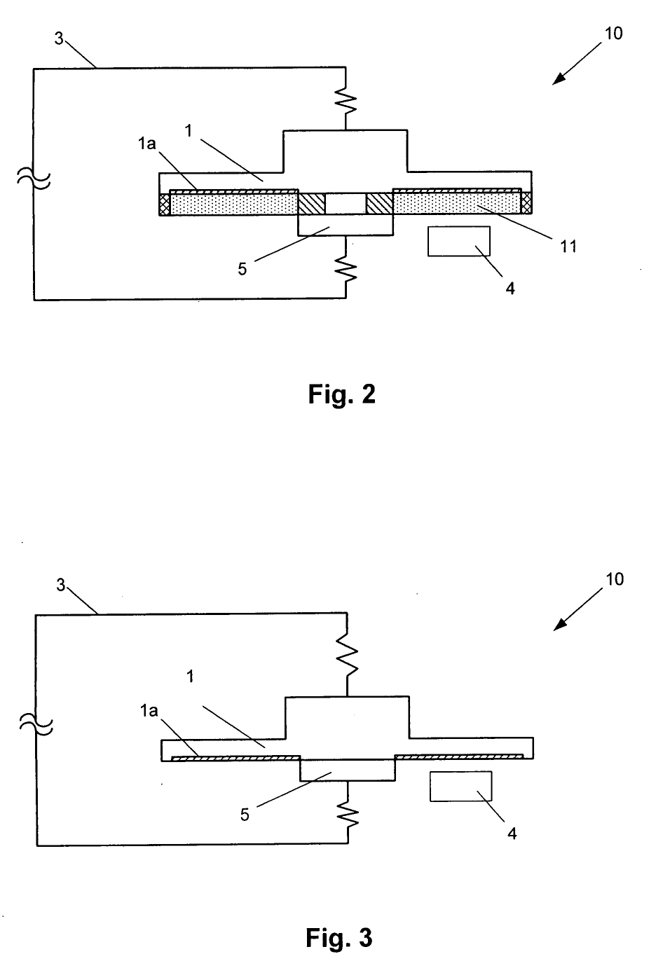

FIG. 2 is a cross-sectional view of a drive 10 according to an advantageous embodiment of the present invention, with an inserted data carrier. In this exemplary embodiment the drive 10 is a CD drive, and the data carrier 11 corresponds to the CD of FIG. 1. The exemplary holding disk 1 of the drive 10 has a larger diameter than conventional CD drives. Its diameter is selected such that a substantially circular surface 1a is defined, having a diameter corresponding to the outer diameter of the CD of FIG. 1. In the circular surface 1a, which corresponds to the CD optics area 6 of the CD, the holding disk 1 is provided with CD-like data structures. In addition, the circular surface 1a is provided with characteristic defects (such as scratches) so that it may be used as a reference surface within the scope of the invention. When the data carrier 11 is inserted, a contact pressure mechanism 3 of the drive 10 may be used for clamping the data carrier 11 between a drive actuator 5, which can be rotated by a motor, and the holding disk 1. The data carrier 11 can then be caused to rotate by way of the drive actuator 5 and can be scanned by a laser lens system 4.

FIG. 3 shows the same drive 10 without an inserted data carrier 11. According to an embodiment of the invention, the contact pressure mechanism 3 of the drive 10 is constructed such that, while in the unloaded condition (without a CD in the drive), the enlarged holding disk 1 can be moved downward to such an extent that it is pressed onto the drive actuator 5. The holding disk 1 is thus caused to rotate as a result of this connection, for example a frictional connection. Because of the extended downward-move and the rotation of the holding disk 1, the reference surface 1a of the holding disk 1 now rotates at the level at which the surface of the data carrier 11 would rotate if the data carrier 11 were inserted. Instead of a CD, the reference surface formed on the circular surface 1a can thereby be scanned by the laser lens system 4.

According to the invention, the permanent integration into the drive 10 of the reference data carrier, the internal reference of the circular surface 1a is exposed to no external environmental influences, such as sun radiation and scratches, and is subjected to very little or imperceptible wear.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drive for a changeable data carrier whose surface is scannable by a reading unit for the read-out of data stored on the changeable data carrier, comprising a reference surface of the drive, which is not part of the changeable data carrier and which is scannable by the reading unit for reference purposes.

2. The drive according to claim 1, wherein the scanning takes place in a non-contact manner.

3. The drive according to claim 1, wherein the reading unit comprises a laser reading unit.

4. The drive according to claim 1, wherein the changeable data carrier is substantially circular-disk-shaped.

5. The drive according to claim 1, wherein the changeable data carrier is one of a CD and DVD.

6. The drive according to claim 1, wherein the reference surface is arranged on a side of a drive actuator facing the reading unit.

7. The drive according to claim 6, wherein the drive actuator rotates during scanning of the reference surface.

8. The drive according to claim 1, further comprising a holding disk defining the reference surface, wherein rotation thereof results from a contact pressure with a rotating drive actuator.

9. The drive according to claim 1, wherein a reading distance between the reading unit and the reference surface is adjustable to correspond to a reading distance between the reading unit and the changeable data carrier inserted therein.

10. The drive according to claim 1, further comprising a transport mechanism of the drive for removing the changeable data carrier inserted therein, to permit scanning of the reference surface by the reading unit.

11. A changeable data carrier drive, comprising:
a holding disk for receiving the changeable data carrier;
a drive actuator for rotating the holding disk;
a reading unit adjacent to the holding disk, for reading data form the changeable data carrier; and
a reference surface integral with the holding disk, the reference surface having a data structure with characteristic defects readable by the reading unit.

12. The changeable data carrier drive according to claim 11, wherein a distance between the reference surface and the reading unit is variable.

13. The changeable data carrier drive according to claim 12, wherein the variable distance substantially equals a reading distance between the reading unit and a surface of the changeable data carrier.

14. The changeable data carrier drive according to claim 11, wherein the reading unit is movable into a facing relationship with the reference surface.

15. The changeable data carrier drive according to claim 11, further comprising a transport mechanism to displace the changeable data carrier form the holding disk, thereby uncovering the reference surface.

16. The changeable data carrier drive according to claim 11, wherein the reading unit is a laser reading unit.

17. A drive for a changeable data carrier, comprising:
a reading unit adapted for reading data structures of the changeable data carrier;
a reference surface integral with the drive, the reference surface comprising characteristic defects for checking the drive; and
a mechanism for placing the reading unit in reading relationship with at least one of the changeable data carrier and the reference surface.

18. The drive according to claim 17, wherein the reference surface is integral with a holding disk for receiving the changeable data carrier.

19. The drive according to claim 17, wherein the mechanism further comprises elements to vary a distance between the reading unit and the reference surface.

20. The drive according to claim 18, wherein the mechanism further comprises elements for displacing the changeable data carrier from the holding disk, thus placing the reading unit in reading relationship with the reference surface.
